(19) United States
(12) Patent Application Publication
(10) Pub. No.: US 2021/0050131 A1
(43) Pub. Date: Feb. 18, 2021

(54) COMMUNICATION CABLE

(71) Applicants: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(72) Inventors: Takaki ENDO, Yokkaichi-shi (JP); Kinji TAGUCHI, Yokkaichi-shi (JP); Toru SHIMIZU, Yokkaichi-shi (JP); Satoshi OKANO, Kanuma-shi (JP)

(73) Assignees: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(21) Appl. No.: 17/051,305

(22) PCT Filed: May 15, 2019
(86) PCT No.: PCT/JP2019/019199

§ 371 Date: Oct. 28, 2020

(30) Foreign Application Priority Data
May 18, 2018 (JP) 2018-096195

(51) Int. Cl. H01B 11/18; H01B 11/00

(52) U.S. Cl. CPC H01B 11/1869; H01B 11/1813; H01B 11/002

(57) ABSTRACT

A communication cable contains: at least one signal line including a pair of insulated wires placed side by side, each insulated wire having a conductor and an insulation covering which covers the conductor; a shielding body which covers the at least one signal line; a sheath which covers the shielding body; and a bend restricting member which restricts bending of the at least one signal line in a lateral direction a which is a direction along which the pair of insulated wires are placed side by side, as compared with bending of the at least one signal line in a vertical direction intersecting the lateral direction.

### TECHNICAL FIELD

The present disclosure relates to communication cables.

### BACKGROUND ART

In the field of high speed communication, signal transmission in differential transmission mode is performed with the use of communication cables, which are called twinaxial cables and shielded parallel pair (SPP) cables. FIG. 8 illustrates a common example of structure of such a conventional type of communication cable. A communication cable 9 has a signal line 90 with a pair of insulated wires 91, 91 running side by side. A shielding body is placed on the outer periphery of the signal line 90. The shielding body includes a film-shaped shield 92 such as a metal tape and a braided shield 93 stacked together. Further, a sheath 94 made of an insulation resin is placed on the outer periphery of the shielding body.

Recently, a communication cable having a signal line containing a pair of insulated wires running side by side as described above has been planned to be used in a vehicle such as an automobile. For use of the communication cable in the vehicles, the necessity for application of a bend to the communication cable may often arise from a requirement to carryout cabling in a confined space or in a complicated route, for example.

If bending is applied to the signal line in the communication cable, the bending may exert influence on the transmission characteristics of the cable, and therefore measures are proposed for suppression of such influence of the bending. For example, Patent Literature 1 describes a twinaxial cable having a drain wire and a shield tape. In the cable, the relative positions of two insulated wires and a drain wire are determined in order to achieve a smaller intra-pair delay skew in the bent conditions.

### CITATION LIST

### Patent Literature

Patent Literature 1: JP 2015-210919 A

### SUMMARY OF INVENTION

### Technical Problem

As described above, for a communication cable, suppression of the influence on the transmission characteristics when bending is applied to the cable is important if the communication cable is used in a condition subjected to bending in a space such as within a vehicle. Further, in addition to the suppression of the influence when bending is applied, prevention of application of a load to the signal line by excessive bending is also important. If a large load is applied to the signal line by the bending, then the load may not only cause influence on the transmission characteristics, but also may shorten the life of the signal line.

As illustrated in FIG. 8, in the communication cable 9 having the signal line 90 containing the insulated wires 91, 91 placed side by side, a side-by-side direction of the insulated wires 91, 91 is assumed as a lateral direction a, while a direction perpendicular to the lateral direction a is assumed as a vertical direction b. In this case, for bending the communication cable 9 at an axial midway portion in the vertical direction b, the communication cable 9 can be bent in the vertical direction b without application of a large load to the signal line 90. On the other hand, for bending the communication cable 9 at an axially midway portion in the lateral direction a, a large load will be applied to the signal line 90 upon bending of the signal line 90 in the lateral direction a.

It is an object of the present disclosure to provide a communication cable having a signal line containing a pair of insulated wires running side by side, which is capable of reducing a load applied to the signal line upon bending of the communication cable in a lateral direction.

### Solution to Problem

A communication cable according to the present disclosure includes: at least one signal line including a pair of insulated wires placed side by side, each insulated wire having a conductor and an insulation covering which covers the conductor; a shielding body which covers the at least one signal line; a sheath which covers the shielding body; and a bend restricting member which restricts bending of the at least one signal line in a lateral direction along which the pair of insulated wires are placed side by side, as compared with bending of the at least one signal line in a vertical direction intersecting the lateral direction.

### Advantageous Effects of Invention

The communication cable according to the present disclosure has the bend restricting member which restrict bending of the signal line in the lateral direction as compared with bending in the vertical direction. The bend restricting member helps to avoid application of a large load to the signal line of the communication cable due to the bending in the lateral direction.

### BRIEF DESCRIPTION OF DRAWINGS

FIG. 1 is a cross-sectional perspective view illustrating a communication cable according to a first embodiment of the present disclosure.

FIGS. 2A 2B are cross-sectional views of the communication cable FIG. 2A illustrates a state subjected to no twist. FIG. 2B illustrates a state subjected to a twist state and corresponds to the cross-section along the line A-A in FIG. 3B.

FIGS. 3A and 3B are views explaining bending of the communication cable. FIG. 3A illustrates a state before application of bending. FIG. 3B illustrates a state after application of bending.

FIGS. 4A and 4B are cross-sectional views of a communication cable according to modified embodiments in which multiple signal lines run side by side. FIG. 4A illustrates a form containing only a film-shaped shield as a shielding body. FIG. 4B illustrates a form containing a combination of a braided shield and a film-shaped shield as a shielding body.

FIG. 5 is a cross-sectional view of a communication cable according to a modified embodiment in which insulation coverings of a pair of insulated wires are integrally formed.

FIG. 6 is a cross-sectional view of a communication cable according to a second embodiment of the present disclosure.

FIG. 7 is a cross-sectional view of a communication cable according to a third embodiment of the present disclosure.

FIG. 8 is a cross-sectional view of a conventional communication cable.

### DESCRIPTION OF EMBODIMENTS

### Description of Embodiments of Present Disclosure

First, embodiments of the present disclosure will be listed and described.

A communication cable according to the present disclosure has: at least one signal line with a pair of insulated wires placed side by side, each insulated wire having a conductor and an insulation covering which covers the conductor; a shielding body which covers the at least one signal line; a sheath which covers the shielding body; and a bend restricting member which restricts bending of the at least one signal line in a lateral direction along which the pair of insulated wires are placed side by side, as compared with bending of the at least one signal line in a vertical direction intersecting the lateral direction.

The communication cable has the bend restricting member which restricts bending of the signal line in the lateral direction as compared with bending in the vertical direction. Since the signal line includes a pair of insulated wires aligned in the lateral direction, the load when bending is applied in the lateral direction is likely to be larger than the load when bending is applied in the vertical direction. However, the communication cable has the bend restricting member to restrict the bending of the signal line in the lateral direction, thereby helping to avoid of application of a large load to the signal line due to the bending in the lateral direction.

When the communication cable is subjected to an external force to act to cause bending in the lateral direction, the bend restricting member restricts the bending of the signal line in the lateral direction, and thus the external force is absorbed by twisting of the communication cable. Alternatively, the bend restricting member guides the bending direction such that the signal cable is bent in the vertical direction rather than in the lateral direction. In this way, the presence of the bend restricting member enables application of bend to the entire communication cable while avoiding application of a large load to the signal line due to the bending in the lateral direction, in the case where the communication cable is used for applications requiring bends in a space such as within a vehicle.

Here, the bend restricting member may include a member which has flexibility in an axis direction of the at least one signal line, and is either placed outside the at least one signal line only in the lateral direction or has lateral and vertical portions placed outside the at least one signal line in the lateral and vertical directions respectively, the lateral portion having a larger thickness than the vertical portion. In this case, a thick member is placed outside the signal line in the lateral direction, thereby preventing the bending of the communication cable in the lateral direction. On the other, such a member is not placed in the vertical direction, or even if placed, the thickness thereof is smaller. Accordingly, the bending of the cable in the vertical direction is hardly prohibited. In this manner, the flexible member is placed unequally around the signal line, thereby effectively restricting the bending of the signal line in the lateral direction.

In this case, it is preferable that the sheath has a flat outer shape which is longer along the lateral direction, and the sheath is made of a constituent material which acts as the restricting member, having the lateral and vertical portions placed outside the at least one signal line in the lateral and vertical directions respectively, the lateral portion having a larger thickness than the vertical portion. Then, when the sheath is formed such as through extrusion molding, the sheath can be formed in a flat shape with unequal wall thicknesses in the vertical direction and the lateral direction, whereby the bend restricting member can be readily formed which effectively restricts the bending of the signal line in the lateral direction.

Further, it is preferable that the at least one signal line includes a plurality of signal lines aligned in the lateral direction, and the sheath covers an assembly of the plurality of signal lines. Then, as compared with the case where the outer periphery of only one pair of signal lines is covered with the sheath, the degree of flatness of a cross-sectional shape of the sheath is greater. Thus, the bending of the signal line in the lateral direction is restricted to a higher degree.

Further, it is preferable that the constituent material of the sheath is placed continuously throughout an outer peripheral section corresponding to the outside of the assembly of the plurality of signal lines and a middle section corresponding to spaces between the plurality of signal lines, and that the lateral portion of the constituent material has a larger thickness than the vertical portion when thicknesses of the material in the peripheral and middle sections are summed up. Then, a large difference is readily produced between the thicknesses of the sheath placed outside the signal lines in the lateral direction and the vertical direction where the thickness in the lateral direction is evaluated as the sum of the thicknesses in the outer peripheral section and the middle section. Thus, in addition to the effect of increasing the degree of flatness of the cross-sectional shape of the communication cable, the bending of the signal lines in the lateral direction is restricted to a higher degree.

Alternatively, it is also preferable that the bend restricting member includes a high tensile fiber placed outside the at least one signal line in the lateral direction, extending along the axis direction of the at least one signal line. Then, the communication cable is prevented from being bent in the lateral direction by the presence of a high tensile fiber. Thus, the bending of the signal line in the lateral direction is effectively restricted by the high tensile fiber.

Further, the bend restricting member may include a member, placed outside the at least one signal line, which has a larger size in the lateral direction than in the vertical direction and a higher stiffness than the sheath. Then, the bend restricting member is relatively easy to be bent in the vertical direction while being hard to be bent in the lateral direction. Thus, the bending of the signal line in the lateral direction is effectively restricted.

In this case, it is preferable that the bend restricting member is a resin plate which is placed outside the at least one signal line in the vertical direction with a plane of the plate extending along an axis direction of the at least one signal line. Then, the resin plate is hard to be subjected to bending in the lateral direction corresponding to folding in a plane of the plate, while the resin plate is relatively easy to be subjected to bending in the vertical direct ion corresponding to warping in the direction of the thickness of the plate. Thus, the bending of the signal line in the lateral direction is strongly restricted, while the ease of bending in the vertical direction is effectively ensured. Further, the bend restricting member with a larger size in the lateral direction is placed outside the signal line in the vertical direction, whereby, as compared with the case where the member is placed in other positions, such as outside the signal line in the lateral direction, increase in diameter of the entire communication cable is inhibited and also a higher balance is achieved in the signal line.

In each case described above, the insulation coverings of the pair of insulated wires are preferably formed integrally. Then, a gap between the conductors constituting a pair of insulated wires is filled with the constituent material of the insulation coverings as a continuum body, and the constituent material serves to restrict bending of the signal line in the lateral direction, as well as the bend restricting member. As a result, restricting the bending of the signal line in the lateral direction is assisted.

### Details of Embodiments of Disclosure

Communication cables according to embodiments of the present disclosure will now be described in details with reference to the accompanying drawings. As used herein, the concepts regarding shapes of elements/components such as “approximately parallel” and “approximately circle”, are not limited to strict geometric shapes such as precisely parallel and precisely circular shapes, and encompass deviations within a range allowable for communication cables.

### Outline of Configuration of Communication Cables

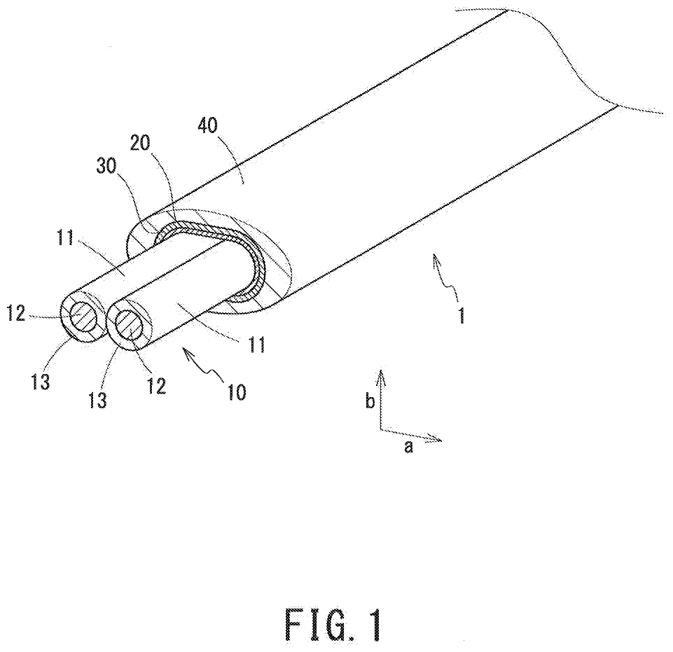

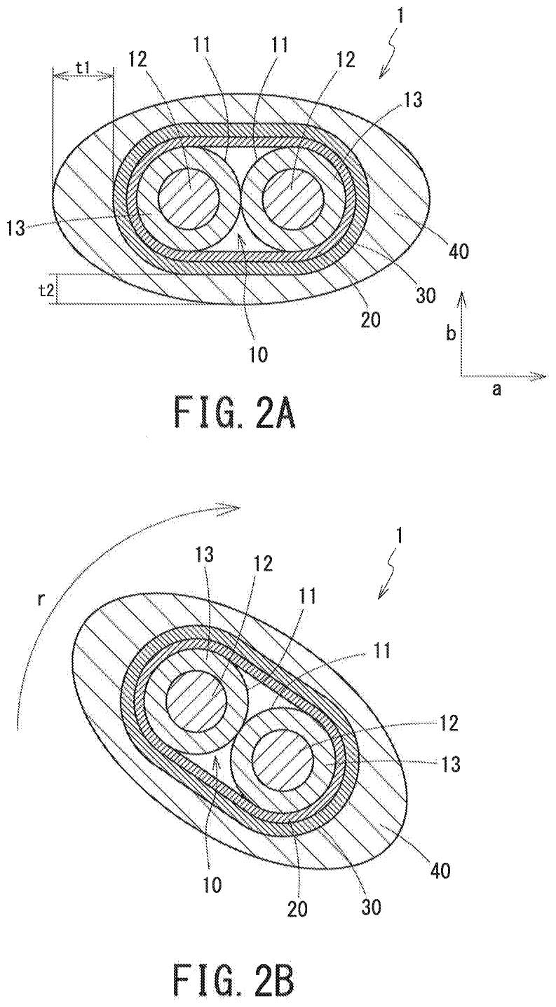

Prior to the description of communication cables according to several embodiments, the following description will be given first on the outline of configurations common to the embodiments by, taking as an example a communication cable 1 according to a first embodiment illustrated in FIGS. 1, 2A, and 2B.

The communication cable 1 (or either of 1A to 1D, the same throughout this section) has a signal line 10 including a pair of insulated wires 11, 11. The communication cable 1 also has a shielding body 20, 30 covering the signal line 10, and a sheath 40 covering the shielding body 20, 30.

Each of the insulated wires 11 constituting the signal line has a conductor 12 and an insulation covering 13 covering the conductor 12. The conductor 12 preferably is a stranded conductor in terms of flexibility. In the signal line 10, a pair of insulated wires 11, 11 are placed side by side and are formed as parallel pair wires arranged in approximately parallel in the axis direction in contact with each other. The signal line 10 can transmit differential mode signals.

The shielding body covering the signal line 10 includes at least one of a film-shaped shield 20 and a braided shield 30. The film-shaped shield 20 is made of a film-shaped material with a metal film, which is a composite material, such as a metal tape, which contains a metal film and a substrate made of a material such as a polymer sheet in combination. Alternatively, the film-shaped shield 20 may be formed by use of a single metal film (i.e., a metal foil) alone. The braided shield 30 is formed by braiding thin metal wires into a hollow tubular shape. A served shield may be placed in lieu of the braided shield 30. The served shield is formed by wrapping thin metal wires around the signal line 10 in a spiral fashion.

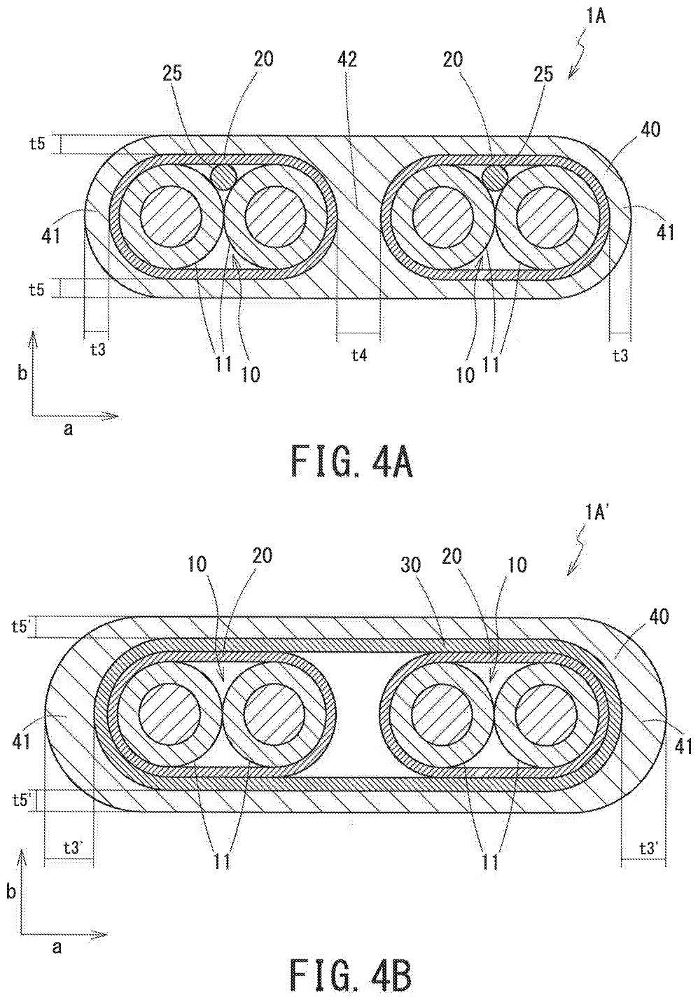

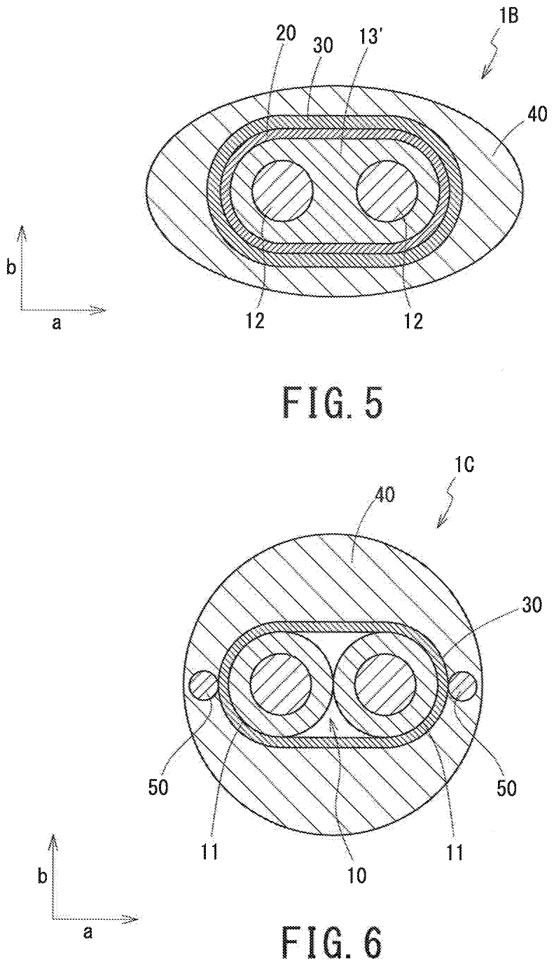

The film-shaped shield 20 and the braided shield 30 serve as a shielding body to block external noise from intruding into the signal line 10 and also block noise from being emitted externally from the signal line 10. Because the signal line 10 is formed as a parallel pair cable without a twist structure, the signal line 10 is more susceptible to in-phase mode noise from the outside than a signal line having a twist structure is. However, the use of the shielding body 20, 30 serves to reduce the influence of external noise. Presence of both the film-shaped shield 20 and the braided shield 30 stacked together enables particularly effective reduction of noise. In this case, the stacking order of the film-shaped shield 20 and the braided shield 30 is not limited; however, if the film-shaped shield 20 is placed inside and the braided shield 30 is placed outside as illustrated in FIGS. 1, 2A, and 2B, a greater effect of improving the transmission characteristics can be produced by the film-shaped shield 20. Also, the resin material forming the sheath 40 is deposited in the mesh of the braided shield 30 to improve adhesion between the shielding body 20, 30 and the sheath 40. In the cases where sufficient shielding performance is ensured by only one of the film-shaped shield 20 and the braided shield 30, any one of the film-shaped shield 20 and the braided shield 30 may be used as a shielding body alone. When only the film-shaped shield 20 is used without the braided shield 30, it is preferable that a drain wire 25 is placed, for grounding, within a region enclosed by the film-shaped shield 20, and conduction between the drain wire 25 and the film-shaped shield 20 is ensured (see FIG. 4A).

The sheath (i.e., jacket) 40 is made of an insulating material such as a resin material, and covers the shielding body 20, 30. The sheath 40 serves to protect for the signal line 10 and the shielding body 20, 30 physically, and to inhibit the characteristics of the communication cable 1 from being influenced by contact with a substance such as water.

The communication cable 1 according to embodiments of the present disclosure has a bend restricting member in addition to the components described above. Here, in the signal line 10, a direction along which the pair of insulated wires 11, 11 are placed side by side is defined as a lateral direction a, and a direction crossing (i.e., perpendicular to) the lateral direction a is defined as a vertical direction b. The bend restricting member serves to restrict bending of the signal line 10 in the lateral direction a as compared with bending in the vertical direction b. Specifically, the bend restricting member inhibits bending of the signal line 10 in the lateral direction a when a certain force is applied to the signal line 10 to bend the signal line 10 at a midway portion in the axis direction, as compared with the case where the same force is applied to the signal line 10 to bend the signal line 10 in the vertical direction b.

As long as the bend restricting member serve the functions as described above, any specific configuration is not limited, and communication cables according to the respective embodiments described below have bend restricting members of different forms. Byway of example, representative forms of the bend restricting member are illustrated below.

<Type A> The bend restricting member has flexibility in the axis direction of the signal line 10. The bend restricting member is either placed outside the signal line 10 only in the lateral direction a, or has lateral and vertical portions placed outside the signal line 10 in the lateral direction a and vertical direction b, respectively. The lateral portion has a larger thickness than the vertical portion.
<Type B> The bend restricting member takes the form of a member which is placed outside the signal line 10 in the vertical direction b. The member has a larger size in the lateral direction a than in the vertical direction b, and has a higher stiffness than the sheath 40.

In Type A described above, the bend restricting member has flexibility in the axis direction of the signal line 10, and thus the material forming the bend restricting member itself allows bending in both the vertical direction b and the lateral direction a. The material achieves, however, the function of restricting the bending direction of the signal line 10 by its positional relationship with the signal line 10. Specifically, the constituent material of the bend restricting member has a larger thickness outside the signal line 10 in the lateral direction a, so that the constituent material inhibits the bending of the signal line 10 in the lateral direction a as compared with the bending in the vertical direction b. In contrast, in Type B, because the bend restricting member possess a higher stiffness than that of the sheath 40, the bending of the signal line 10 is suppressed in both the vertical direction b and the lateral direction a. Since the bend restricting member has a shape with a small thickness in the vertical direction b, the degree of bending suppression is smaller in the bending in the vertical direction b than in the bending in the lateral direction a. Thus, the bending in the lateral direction a can be relatively prevented.

The communication cable 1 according to the embodiment of the present disclosure includes the signal line 10 including parallel pair wires, and further has a shielding body 20, 30 around the signal line 10. The communication cable 1 may be suitably used for transmission of differential signals in a high frequency band such as 1 GHz or higher. When the signal line 10 is subjected to a load due to bending, the bending possibly exerts influence on the transmission characteristics. Further, the load caused by the bending possibly shorten the life of the communication cable 1. The signal line 10 has the structure of a pair of insulated wires 11, 11 placed side by side, and thereby has anisotropy in magnitude of load applied by bending. Specifically, when the signal line 10 is bent at a midway portion in the axis direction, if bent is performed in the vertical direction b, a large load is not applied to the signal line 10, whereas if bent is performed in the lateral direction a, a large load is applied to the signal line 10.

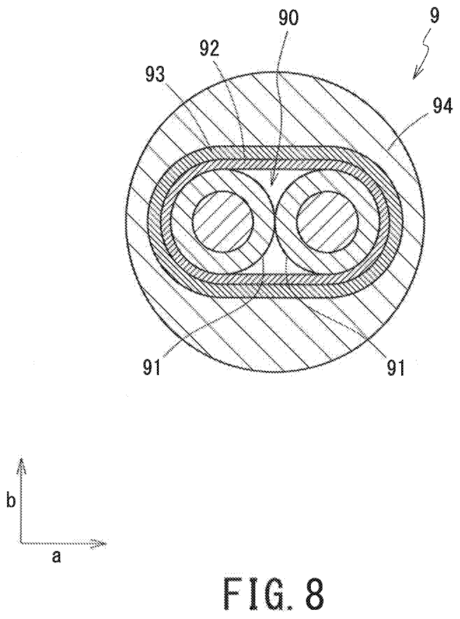

The communication cable 1 according to the embodiment of the present disclosure has a bend restricting member as described above, whereby bending of the signal line 10 in the lateral direction a less easily occurs than in the case of the conventional communication cable 9 having no bend restricting member as illustrated in FIG. 8. Therefore, the load applied to the signal line 10 by bending is reduced. As a result, the influence on the transmission characteristics by the load due to the bending is suppressed, and the life of the signal line 10 under application of bending is improved.

Embodiments of communication cables having various types of bend restricting members will now be described. In each embodiment, common reference signs are used to indicate the members corresponding to each other. The bend restricting members of various types may be used in a combination of two or more types.

### First Embodiment: Cable Having Sheath of Flat Shape

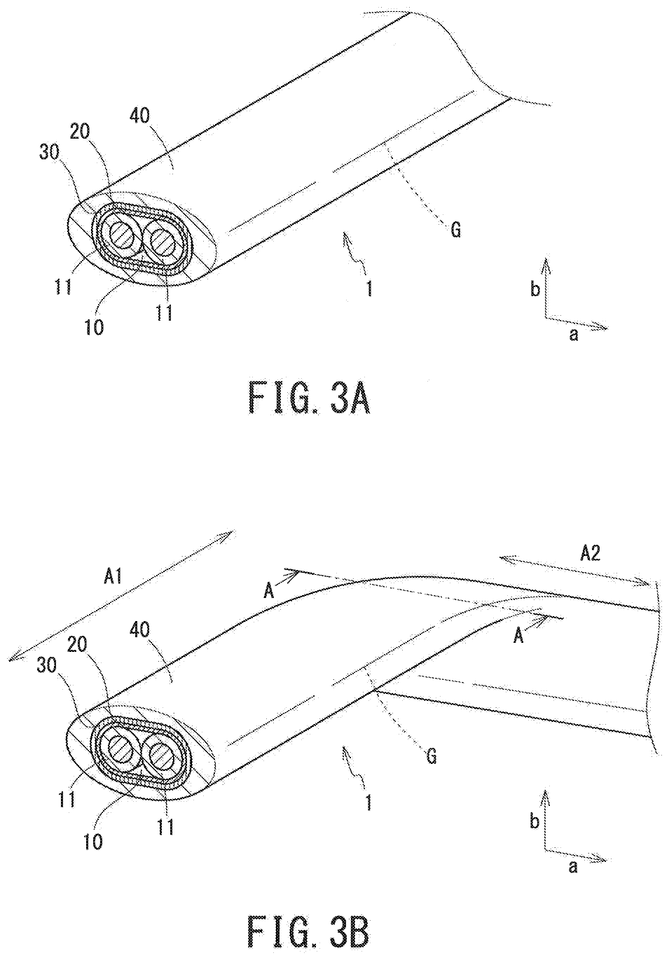

FIGS. 1, 2A, and 2B illustrate the configuration of the communication cable 1 according to a first embodiment of the present disclosure. FIGS. 3A and 3B also illustrate the communication cable 1 upon bending.

The communication cable 1 according to the embodiment has: the signal line 10 including a pair of insulated wires 11, 11 placed side by side; the shielding body made up of the film-shaped shield 20 and the braided shield 30 covering the signal line 10; and the sheath 40 covering the shielding body 20, 30, as described above. Here, the sheath 40 has a flat shape, and the flat shape allows the sheath 40 itself to function as a bent restricting member of Type A described above.

Specifically, the sheath 40 has a flat outer shape which is longer in the lateral direction a. That is, as illustrated in FIG. 2A, in a cross-sectional outer shape of the sheath 40, a maximum size in the lateral direction a is greater than that in the vertical direction b. In the illustrated form, the cross-sectional outer shape of the sheath 40 is an ellipse. Further, a constituent material of the sheath 40 has a larger thickness in the portion placed outside the signal line 10 in the lateral direction a than in the portion placed outside in the vertical direction b. Specifically, a maximum value t1 of a wall thickness of the sheath 40 in the lateral direction a is larger than a maximum value t2 of a wall thickness of the sheath 40 in the vertical direction b (t1>t2)

As illustrated in FIG. 8, in the conventional communication cable 9, the cross-sectional outer shape of the sheath 94 is approximately circular. The signal line 90 has a laterally long shape by including a pair of insulated wires 91, 91 aligned laterally, so that the outer shape of an assembly including the signal line 90 and the film-shaped shield 92 and the braided shield 93 which cover the signal line 90 has also a laterally long, flat shape. The sheath 94 of approximately circular cross section is placed over such a flat shape, whereby the wall thickness of the sheath 94 is smaller in the lateral direction a than in the vertical direction b. In this manner, the sheath 94 has a smaller wall thickness outside the signal line 90 in the lateral direction a. Thus, the sheath 94 hardly prevents the bending of the signal line 90 in the lateral direction a. As described above, when the signal line 90 is bent in the lateral direction a, a larger load will be applied to the signal line 90 than in the case where it is bent in the vertical direction b.

In contrast to the case of the above-described communication cable 9, in the communication cable 1 according to the present embodiment, the sheath 40 has a flat outer shape, and has a larger wall thickness in the lateral direction a than in the vertical direction b, whereby the bending of the signal line 10 in the lateral direction a can be restricted as compared with the bending in the vertical direction b. The reason for this is as follows: in order to bend the entire communication cable 1 in the vertical direction b, all that is required is to bend and deform the thin sheath material, and only a small amount of bend deformation is required for the sheath 40. On the other hand, in order to bend the cable 1 in the lateral direction a, bend deformation in the thick sheath material is required, and additionally, the amount of bending deformation is increased to compress the sheath material located on the inner side of the bend and to stretch the sheath material located on the outer side.

Here, a situation is assumed where the communication cable 1 having such a flat sheath 40 is bent at an axially midway portion toward the lateral direction a as illustrated in FIG. 3A. Such bending is created on a cabling route, for example, in cases where one end of the communication cable 1 is connected to a device located in the lateral direction a with respect to the axis direction. When bending is applied to the communication cable 1 in the lateral direction, a force is applied to a back portion of the cable 1 toward the lateral direction a (i.e., a rightward direction of the figure) in a plane (i.e., bending plane) including the lateral direction a and the axis direction while a front portion of the cable is fixed. Here the back portion where the force is applied is located, in the figure, in back of the point to be bent, while the front portion kept fixed is located in front of the point.

On this occasion, as described above, the constituent material of the sheath 40 of a flat shape formed with a larger thickness in the lateral direction a acts as a bend restricting member, so that the signal line 10 and the communication cable 1 are entirely prevented from being bent directly in the lateral direction a in the bending plane. Stated another way, the communication cable 1 can not be bent in the lateral direction a while keeping the direction of side-by-side placement of the pair of insulated wires 11, 11 within the bending plane. Then, as illustrated in the perspective view of FIG. 3B and the A-A cross-sectional view of FIG. 2B, the communication cable 1 is rotated and twisted around the axis direction (by motion r). Accompanied by this twist, as shown by imaginary guide lines G in FIGS. 3A and 3B, the axis direction of the communication cable 1 is bent out of the plane. Then, between regions A1 and A2 in front and back of the point to be bent, across-section direction of the communication cable 1 is rotated approximately at 90 degrees. Specifically, in the region A1 on the front side, the pair of insulated wires 11, 11 are maintained to be positioned side by side in the lateral direction a, whereas, in the region A2 on the back side, the pair of insulated wires 11, 11 become positioned side by side in the vertical direction b.

In this way, the twist of the entire communication cable 1 absorbs the force applied to the entire communication cable 1 toward the lateral direction a in the bending plane. This results in reduction of the force which is applied to the signal line 10 located within the region enclosed by the sheath 40 to bend the signal line 10 in the lateral direction a, so that bending of the signal line 10 in the lateral direction a in the bending plane is avoided. The signal line 10 follows the bend in the entire shape of the communication cable 1 mainly by a twist accompanying bending in the vertical direction b rather than bending in the lateral direction a. Restriction of the bending of the signal line 10 in the lateral direction a prevents the signal line 10 from being subjected to a large load by the bending, thus suppressing influences on the transmission characteristics caused by the load due to such bending, and inhibiting reduction of life.

The constituent material for the sheath 40 is not particularly limited, but materials with relatively low flexibility provides beneficial effects of preventing the bending of the signal line 10 in the lateral direction a. For example, at least the wall thickness t1 in the lateral direction a is preferably formed to be greater than the wall thickness of the insulation covering 13.

The sheath 40, which is conventionally contained in a communication cable for the purpose of protecting the shielding body 20, 30 and the signal line 10, also serves as the bend restricting member in the present embodiment. Thus, the installation of the bend restricting member into the communication cable 1 is achieved in a simple configuration. Further, when the sheath 40 is formed of a resin composition by extrusion molding, the bend restricting member can be readily formed only by unequally setting wall thicknesses t1, t2 of the sheath 40 in the lateral and the vertical directions.

Modified embodiments may include a communication cable 1A with a plurality of signal lines 10 collectively covered with a flat sheath 40, as illustrated in FIG. 4A. Here, two sets each of which includes a signal line 10 and a drain wire 25 as well as the film-shaped shield 20 covering them, are aligned in the lateral direction a. The outer peripheries of an assembly including the two sets are collectively covered with a continuous sheath 40. The sheath 40 has a flat outer shape which is longer in the lateral direction a. The sheath 40 is placed in outer peripheral sections 41, 41 corresponding to the outside of the assembly containing the two pairs of signal lines 10, as well as a middle section 42 corresponding to a position between the two pairs of signal lines 10. The constituent material of the sheath 40 placed in the outer peripheral sections 41, 41 and the middle section 42 is entirely continuous. When the thicknesses of the constituent material of the sheath 40 in the outer periphery sections 41, 41 and the middle section 42 are summed up, the thickness (t3+t3+t4) of the material placed outside the signal line 10 in the lateral direction a is larger than the thickness (t5+t5) of the material in the vertical direction b.

In this way, by covering a plurality of signal lines 10 with a flat sheath 40, the degree of flatness of the sheath 40 is greater and the sheath 40 is laterally longer than in the case where the sheath 40 covers only one pair of the signal lines 10, as illustrated in FIGS. 1 to 3B. As a result, the flatter shape of the sheath 40 produces a further enhanced effect of restricting the bending of the signal lines 10 in the lateral direction a. Further, the restriction on bending of each signal line 10 in the lateral direction a is provided not only by the sheath material placed in the outer peripheral sections 41, 41 but also by the sheath material placed in the middle section 42. Accordingly, the wall thickness of the sheath 40 which is placed in the lateral direction a of the signal lines 10 and has the effect of preventing bending of the signal line 10 in the lateral direction is defined by the sum of the thicknesses in the outer peripheral sections 41, 41 and the middle section 42. Then, the wall thickness in the lateral direction a as a ratio to the wall thickness in the vertical direction b is larger than in the case where the sheath 40 covers only one pair of signal lines 10. This provides an enhanced effect of restricting the bending of the signal lines 10 in the lateral direction a. If a wall thickness (t3) only in the outer peripheral sections 41, 41 alone is larger than the wall thickness (t5) in the vertical direction b, the bending of the signal line 10 in the lateral direction a is more strongly restricted.

In the communication cable 1A in FIG. 4A, only the film-shaped shields 20 covering the signal lines 10 individually are placed as the shielding body. Alternatively, the braided shield 30 may be further placed such as in a communication cable 1A′ illustrated in FIG. 4B. In this case, the two sets each including the film-shaped shield 20 covering the signal line 10 are placed side by side in the lateral direction a, and the braided shield 30 collectively covers the assembly including the outer peripheries of the two sets. Further the sheath 40 covers the assembly over the braided shield 30 collectively. There is no need to install a drain wire 25.

In this case, the thickness (t3′) of the constituent material of the sheath 40 placed outside the signal line 10 in the lateral direction a (in the outer peripheral sections 41, 41) is larger than the thickness (t5′) in the vertical direction b. As in the case of the communication cable 1A in FIG. 4A, the communication cable 1A′ in this form also has an enhanced effect of restricting bending of the signal line 10 in the lateral direction a due to the flat shape of the sheath 40. Unlike the communication cable 1A in FIG. 4A, no sheath material is placed in a position corresponding to the middle section 42. Although no effect of restricting bending in the lateral direction a is therefore obtained by the sheath material in the middle section 42, the communication cable 1A′ has a simpler configuration because of absence of a drain wire 25.

Modified embodiment may further include a communication cable 1B where a pair of insulated wires has an integrally formed insulation covering 13′. Specifically, two conductors 12, 12 are covered with an integrally continuous insulation covering 13′, without being covered individually with the independent insulation coverings 13 as illustrated in FIGS. 1 to 3B. In this way, by integrally forming the insulation covering 13′, the entire region between the pair of conductors 12, 12 arranged side by side in the lateral direction a is occupied by the constituent material of the insulation covering 13′.

In such a form, the insulation covering material 13′, which occupies the region between the two conductors 12, 12 continuously in the lateral direction a, also has the effect of making the signal line 10 less bendable in the lateral direction a. That is, the insulation covering material 13′ assists the function of the sheath 40 having a flat shape as the bend restricting member. Therefore, in combination with the bend restricting member of various forms including the forms according to the present embodiment, the effect of restricting of bending of the signal line 10 in the lateral direction a can be enhanced in the entire communication cable.

### Second Embodiment: Cable Having High Tensile Fiber

FIG. 6 illustrates a communication cable 1C according to a second embodiment of the present disclosure.

In the communication cable 1C according to the second embodiment, an intervening cord 50 made of high tensile fiber is placed outside in the lateral direction a of an assembly including the signal line 10 and the braided shield 30 covering the signal line 10. The intervening cord 50 is adjacent to the assembly, extending along the axis direction of the signal line 10. Stated another way, the intervening cords 50, 50 are placed via the braided shield 30 on both outer sides of the signal line 10 in the lateral direction a. The intervening cord 50 functions as a bend restricting member according to the above-described Type A. The intervening cord 50 is a long shaped member having flexibility made of high tensile fiber such as an aramid-based material. An intervening cord similar to one placed within a sheath in various well-known cables may be used.

Further, in the communication cable 1C, the sheath 40 covers an assembly including the signal line 10 and the braided shield 30 as well as the intervening cords 50, 50 on both sides. Here, the sheath 40 has an outer shape of approximately circular cross section.

Because the intervening cord 50 is placed outside the signal line 10 in the lateral direction a, not only the signal line 10 but also the intervening cord 50 must be bent in the lateral direction a together in order to bend the communication cable 1C at an axial midway portion in the lateral direction a. Therefore, in comparison with the case where the same force is applied in the bending plane to a cable having no intervening cord 50, it is difficult to apply bending in the lateral direction a to the communication cable 1C. Further, while the communication cable 1C is bent in the lateral direction a, a particularly large tension is applied to the intervening cord 50 located on the outer side of the bending. Unlike the sheath 40, the intervening cord 50 does not extend when a tension is applied. Therefore, the tension applied to the intervening cord 50 acts to cancel the bending of the communication cable 1C in the lateral direction a.

In this way, the presence of the intervening cord 50 prevents the entire communication cable 1C and the signal line 10 from being bent in the lateral direction a, while having not much influence on the bending of the entire communication cable 1C and the signal line 10 in the vertical direction b. Accordingly, the intervening cord 50, placed outside the signal line 10 in the lateral direction a, functions as the bend restricting member which restricts bending in the lateral direction a as compared with bending in the vertical direction b. When one intends to apply bend to the communication cable 1C, the intervening cord 50 as the bend restricting member prevents bending in the lateral direction a, thereby prompting the signal line 10 to be bent in the vertical direction b rather than the lateral direction a, and guiding the bending direction.

Even when the intervening cord 50 is placed only on one of both sides in the lateral direction a of the signal line 10, the intervening cord 50 exerts the effect as the bend restricting member to some extent. In terms of the effective prevention of bending of the signal line 10 toward both sides in the lateral direction a, however, the intervening cords 50, 50 are preferably placed on both sides in the lateral direction a of the signal line 10, as illustrated in FIG. 6. Though intervening cord(s) 50 may be placed outside the signal line 10 also in the vertical direction b, but in this case, the thickness of the region occupied by the intervening cords 50 is required to be larger in the lateral direction a of the signal line 10 than in the vertical direction b.

In the form illustrated in FIG. 6, the intervening cord 50 is placed outside the region enclosed by the braided shield 30. In another possible form, the intervening cord 50 may be placed within the shielding body. However, the intervening cord 50 can exert a greater effect of preventing the bending of the signal line 10 in the lateral direction a when it is placed outside the region enclosed by the braided shield 30 as illustrated in FIG. 6 because of a longer distance from the signal line 10. Further, high balance can be maintained in the signal line 10 more effectively. Meanwhile, when the intervening cord 50 is placed inside the region enclosed by the shielding body, electromagnetic coupling between the insulated wires 11 constituting the signal line 10 is increased, whereby the effects of reducing the skew and improving the noise resistance are enhanced. Further, the intervening cord can be more easily installed in the course of the manufacture of the communication cable 1C.

### Third Embodiment: Cable Having Resin Plate

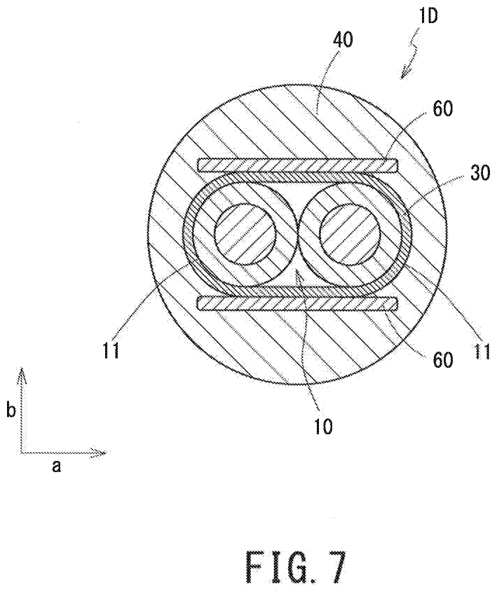

FIG. 7 illustrates the configuration of a communication cable 1D according to a third embodiment of the present disclosure.

In the communication cable 1D according to the third embodiment, a resin plate 60 is placed outside the signal line 10 in the vertical direction b with the plane of the plate extending along the axis direction of the signal line 10. The resin plate 60 possess higher stiffness than the constituent material of the sheath 40, so that the resin plate 60 is more resistant to bending deformation in all directions than the sheath 40. The resin plate 60 functions as the being restricting member according to the above-described Type B.

In the communication cable 1D, the signal line 10 is covered with the braided shield 30. Further, the resin plates 60 are placed in positions outside the braided shield 30 on both sides of the signal line 10 in the vertical direction b. Stated another way, an assembly including the signal line 10 and the braided shield 30 covering the signal line 10 is sandwiched between the two resin plates 60, 60. The assembly including the signal line 10, the braided shield 30 and the resin plates 60, 60 is covered with the sheath 40. In this case, the sheath 40 has an outer shape of approximately circular cross section.

The resin plate 60 can be relatively easily bent in the thickness direction while being warped, but cannot be easily bent in the in-plane direction intersecting the thickness direction. That is, as illustrated in FIG. 7, in the conditions where the resin plate 60 is placed with the plane of the plate extending along the axis direction of the signal line 10 and the thickness direction oriented in the vertical direction b, the resin plate 60 can be relatively easily bent in the vertical direction b, but cannot be easily bent in the lateral direction a.

The communication cable 1D is equipped with the resin plate 60 with higher stiffness than the sheath 40, whereby the bending in both the lateral direction a and the vertical direction b is prevented as compared with the case of a cable having no resin plate 60. However, because of anisotropy in the ease of bending of the resin plate 60 as described above, the degree of prevention of bending is greater for bending in the lateral direction a than for bending in the vertical direction b. In this way, the bending of the communication cable 1D and the signal line 10 in the lateral direction a is restricted as compared with the bending in the vertical direction b, and thus the resin plate 60 functions as the bend restricting member. When one intents to apply a bend to the communication cable 1D, the resin plate 60 as the bend restricting member prevents bending in the lateral direction a more strongly than bending in the vertical direction b, thereby prompting the signal line 10 to be bent in the vertical direction b, rather than the lateral direction a, and guiding guide the bending direction.

A member other than the resin plate 60 may be used as a bend restricting member according to Type B as in the case of the resin plate 60 as long as the member is made of a material possessing higher stiffness than the constituent material of the sheath 40 and is formed in a plate shape with a larger size (width) in the lateral direction a than the size (thickness) in the vertical direction b. However, a material inhibiting any bending in the vertical direction b would make it impossible to bend the communication cable 1D in any direction. Therefore, a material having flexibility to some extent is preferable. Considering this, using a resin plate 60 made of a material such as polyolefin, and polyvinyl chloride is preferable.

The position where such a plate-shaped bend restricting member is placed is not limited to the position outside the signal line 10 in the vertical direction b; it may be placed in any position outside the signal line 10. However, in terms of prevention of excessive increase in diameter of the signal line 10, and in terms of a higher balance in the signal line 10, the bend restricting member is preferably placed outside the signal line 10 in the vertical direction b as in the above-described form. Further, a plate-shaped member 50 having a larger width can be used by placing the plate-shaped member 50 outside the signal line 10 in the vertical direction b. When the plate-shaped member 50 has a larger width, the effect of limiting the bending of the signal line 10 in the lateral direction a is more beneficial. Preferably, the plate-shaped member has a width equal to or greater than a size of the signal line 10 in the lateral direction a. Further, the plate-shaped member may be placed only on one of both sides of the signal line 10 in the vertical direction b, but if placed on both sides, the effect of restricting the bending in the lateral direction a is enhanced.

The present invention is not limited to any of the above-described embodiments, and various modifications are possible without deviating from the scope and spirit of the present invention.

### DESCRIPTION OF EMBODIMENTS

1, 1A to 1D, 1A′ . . . Communication cable
10 . . . Signal line
11 . . . Insulated wire
12 . . . Conductor
13, 13′ . . . Insulation covering
20 . . . Film-shaped shield
25 . . . Drain wire
30 . . . Braided shield
40 . . . Sheath
41 . . . Outer peripheral section
42 . . . Middle section
50 . . . Intervening cord (high tensile fiber)
60 . . . Resin plate
9 . . . Conventional communication cable
90 . . . Signal line
91 . . . Insulated wire
92 . . . Film-shaped shield
93 . . . Braided shield
94 . . . Sheath
a . . . Lateral direction
b . . . Vertical direction
r . . . Rotation motion
t1 . . . Maximum value of sheath wall thickness in the lateral direction
t2 . . . Maximum value of sheath wall thickness in the vertical direction
t3, t3′ . . . Sheath wall thickness in the lateral direction of the outer peripheral section of the signal line
t4 . . . Wall thickness of constituent material of sheath placed between two pairs of signal lines
t5, t5′ . . . Sheath wall thickness in the vertical direction
A1 . . . Region on the front side
A2 . . . Region on the front side
G . . . Guide line

1.-9. (canceled)

10. A communication cable, comprising:
a signal line comprising a pair of insulated wires placed side by side, each insulated wire having a conductor and an insulation covering which covers the conductor;
a shielding body which covers a single one of the signal line; and
a sheath which covers the shielding body, surrounding the single one of the signal line;
wherein when a direction along which the pair of insulated wires are placed side by side is defined as a lateral direction, and a direction intersecting the lateral direction is defined as a vertical direction,
the sheath has a flat outer shape which is longer along the lateral direction,
the sheath comprises a constituent material which has a larger thickness in a portion placed outside the signal line in the lateral direction than in a portion placed outside the signal line in the vertical direction, and
the constituent material acts as a bend restricting member which restricts bending of the signal line in the lateral direction as compared with bending of the signal line in the vertical direction.

11. The communication cable according to claim 10, wherein the sheath has an outer shape of an ellipse cross-section.

12. The communication cable according to claim 10, wherein the insulation coverings of the pair of insulated wires are formed integrally.

13. A communication cable, comprising:
a signal line comprising a pair of insulated wires placed side by side, each insulated wire having a conductor and an insulation covering which covers the conductor;
a shielding body which covers the signal line;
a sheath which covers the shielding body; and
a high tensile fiber,
wherein when a direction along which the pair of insulated wires are placed side by side is defined as a lateral direction, and a direction intersecting the lateral direction is defined as a vertical direction,
the high tensile fiber is placed outside the signal line in the lateral direction, extending along an axis direction of the signal line, and
the high tensile fiber acts as a bend restricting member which restricts bending of the signal line in the lateral direction as compared with bending of the signal line in the vertical direction.

14. The communication cable according to claim 13, wherein the high tensile fiber comprises an aramid-based material.

15. The communication cable according to claim 13, wherein the high tensile fiber is placed outside a region enclosed by the shielding body.

16. The communication cable according to claim 13, wherein the high tensile fiber is placed on both sides of the signal line in the lateral direction.

17. The communication cable according to claim 13, wherein the insulation coverings of the pair of insulated wires are formed integrally.

18. A communication cable, comprising:
a signal line comprising a pair of insulated wires placed side by side, each insulated wire having a conductor and an insulation covering which covers the conductor;
a shielding body which covers the signal line;
a sheath which covers the shielding body; and
a resin plate,
wherein when a direction along which the pair of insulated wires are placed side by side is defined as a lateral direction, and a direction intersecting the lateral direction is defined as a vertical direction,
the resin plate is placed outside the signal line in the vertical direction with a plane of the plate extending along an axis direction of the signal line, and
the resin plate acts as a bend restricting member which restricts bending of the signal line in the lateral direction as compared with bending of the signal line in the vertical direction.

19. The communication cable according to claim 18, wherein the resin plate comprises polyolefin or polyvinyl chloride.

20. The communication cable according to claim 18, wherein the resin plate has a width equal to or larger than a size of the signal line in the lateral direction.

21. The communication cable according to claim 18, wherein the insulation coverings of the pair of insulated wires are formed integrally.
